(19) United States
(12) Patent Application Publication
(10) Pub. No.: US 2002/0190145 A1
(43) Pub. Date: Dec. 19, 2002

(54) Roof cleaning system

(76) Inventor: Glenn T. Sheppard JR., Blounts Creek, NC (US)

Correspondence Address: Michael S. Neustel, Suite No. 4, 2534 South University Drive, Fargo, ND, 58103, US

(21) Appl. No.: 09/882,490

(22) Filed: Jun. 15, 2001

(51) Int. Cl. B05B 3/00

(52) U.S. Cl. 239/754; 239/280; 239/548

(57) ABSTRACT

A roof cleaning system for enabling an individual to conveniently and safely clean a roof or other elevated surface. The roof cleaning system includes a telescoping tube fluidly connectable to a hose of a pump, a main tube fluidly connected to the telescoping tube, a plurality of nozzles fluidly connected within the main tube extending downwardly, a pair of arms attached to opposing ends of the main tube, a pair of cutouts within the arms for slidably receiving a corresponding pair of extended members, and a pair of wheels attached to the extended members for movably supporting the main tube substantially parallel above a surface of a roof.

### BACKGROUND OF THE INVENTION

1. Field of the Invention

The present invention relates generally to roof cleaning devices and more specifically it relates to a roof cleaning system for enabling an individual to conveniently and safely clean a roof or other elevated surface.

2. Description of the Prior Art

Cleaning devices such as pressure washers have been in use for years. A pressure washer is typically comprised of a water pump that receives water from a conventional water source, and a spray wand with a nozzle attached to an end thereof for dispensing pressurized water received from the water pump. For cleaning a roof or other elevated surface, the user must stand directly upon the elevated surface with the spray wand contained within their hand. Another solution for cleaning roofs, particularly roofs with steep inclines, is to utilize an expensive platform lifting machine.

Cleaning a roof or other elevated surface is relatively difficult to accomplish with a pressure washer. Another problem with conventional cleaning devices is that they are relatively dangerous to utilize as they require the user to stand upon the roof or elevated surface.

Examples of patented cleaning devices which are illustrative of such prior art include U.S. Pat. No. 4,095,746 to Anderberg; U.S. Pat. 4,249,767 to Andreasen; U.S. Pat. No. 4,978,241 to Lawson; U.S. Pat. No. 5,653,392 to Wells; U.S. Pat. No. 4,319,851 to Arthur.

While these devices may be suitable for the particular purpose to which they address, they are not as suitable for enabling an individual to conveniently and safely clean a roof or other elevated surface. Conventional cleaning devices, such as a pressure washer, are difficult and unsafe to utilize for cleaning a roof.

In these respects, the roof cleaning system according to the present invention substantially departs from the conventional concepts and designs of the prior art, and in so doing provides an apparatus primarily developed for the purpose of enabling an individual to conveniently and safely clean a roof or other elevated surface.

### SUMMARY OF THE INVENTION

In view of the foregoing disadvantages inherent in the known types of cleaning devices now present in the prior art, the present invention provides a new roof cleaning system construction wherein the same can be utilized for enabling an individual to conveniently and safely clean a roof or other elevated surface.

The general purpose of the present invention, which will be described subsequently in greater detail, is to provide a new roof cleaning system that has many of the advantages of the cleaning devices mentioned heretofore and many novel features that result in a new roof cleaning system which is not anticipated, rendered obvious, suggested, or even implied by any of the prior art cleaning devices, either alone or in any combination thereof.

To attain this, the present invention generally comprises a telescoping tube fluidly connectable to a hose of a pump, a main tube fluidly connected to the telescoping tube, a plurality of nozzles fluidly connected within the main tube extending downwardly, a pair of arms attached to opposing ends of the main tube, a pair of cutouts within the arms for slidably receiving a corresponding pair of extended members, and a pair of wheels attached to the extended members for movably supporting the main tube substantially parallel above a surface of a roof.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a roof cleaning system that will overcome the shortcomings of the prior art devices.

A second object is to provide a roof cleaning system for enabling an individual to conveniently and safely clean a roof or other elevated surface.

Another object is to provide a roof cleaning system that allows an individual to remain upon ground level while pressure washing a roof or other elevated surface.

An additional object is to provide a roof cleaning system that is adjustable in height and spray angle.

A further object is to provide a roof cleaning system that removes debris from a roof such as but not limited to dirt, mold, fungi and contaminants.

Another object is to provide a roof cleaning system that can be effectively utilized by most users.

A further object is to provide a roof cleaning system that does not require the usage of expensive platform lifting machinery.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of the present invention cleaning a roof surface.

FIG. 2 is an upper perspective view of the present invention.

FIG. 3 is a front view of the present invention.

FIG. 4 is a top view of the present invention.

FIG. 5 is a front view of the present invention in use upon a roof surface.

FIG. 6 is a side view of the present invention in use upon the roof surface in a lower position.

FIG. 7 is a side view of the present invention in use upon the roof surface in a raised position.

FIG. 8 is an exploded upper perspective view of the present invention.

### DESCRIPTION OF THE PREFERRED EMBODIMENT

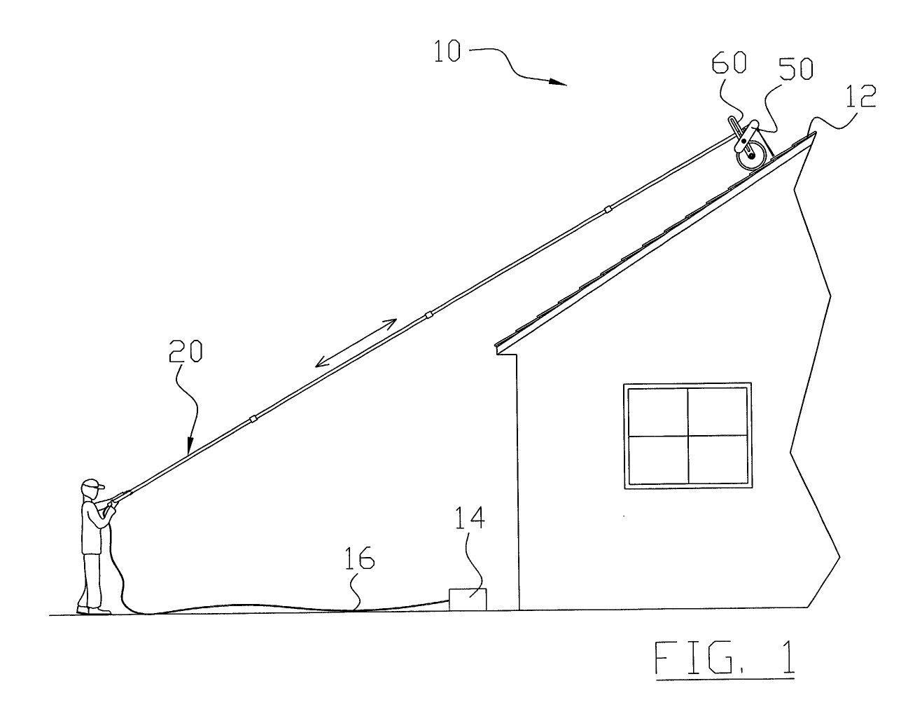

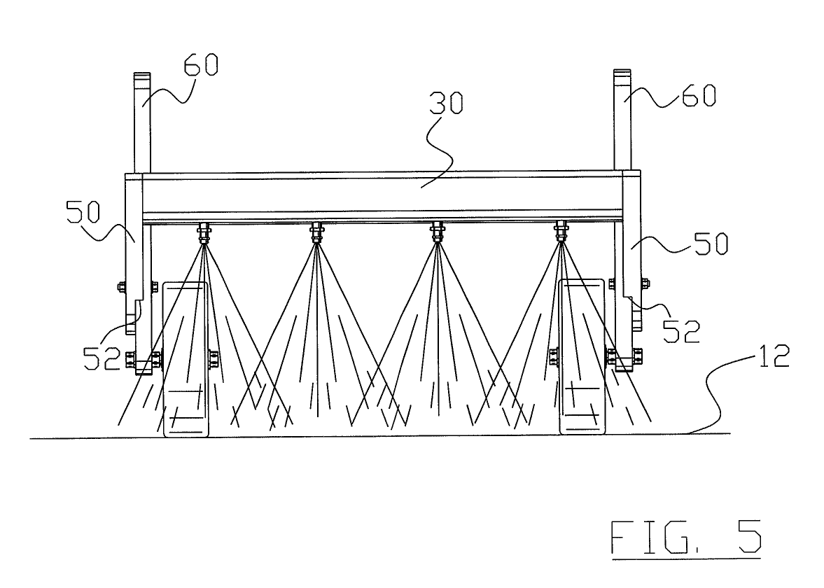

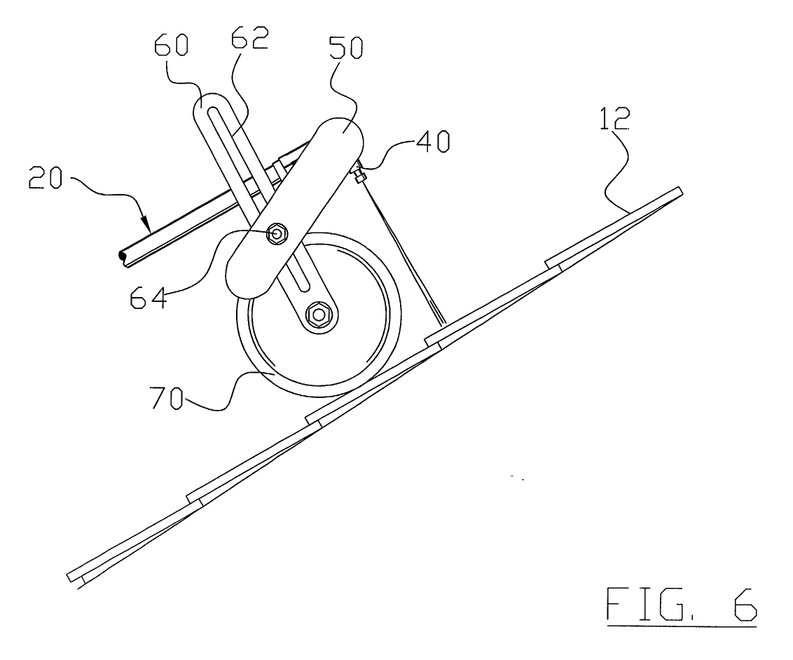

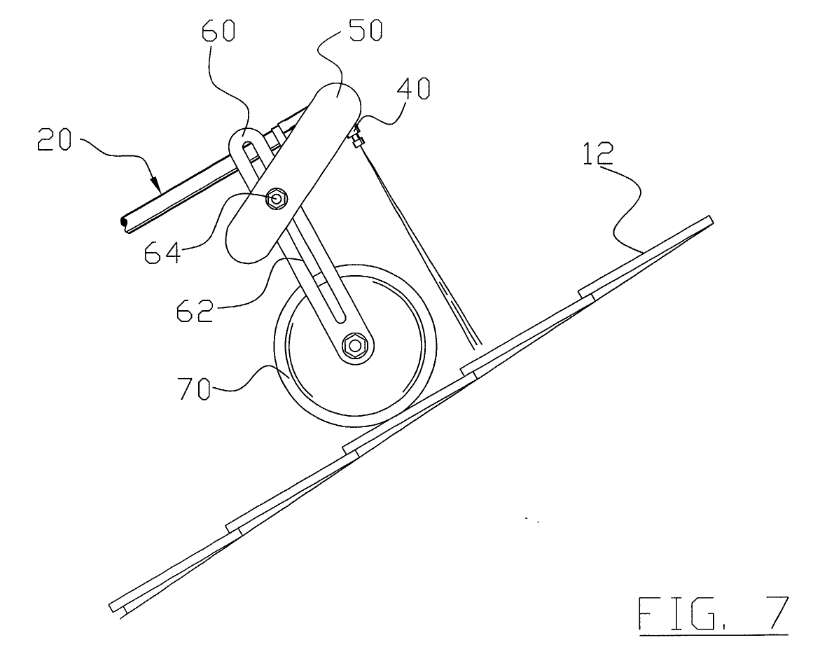

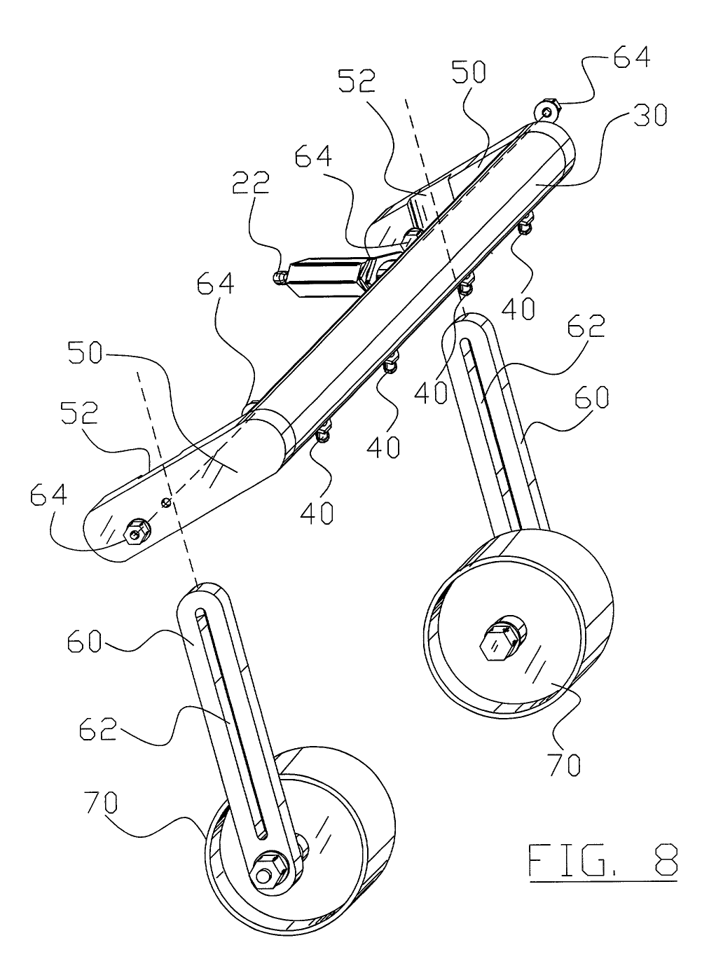

Turning now descriptively to the drawings, in which similar reference characters denote similar elements throughout the several views, FIGS. 1 through 8 illustrate a roof cleaning system 10, which comprises a telescoping tube 20 fluidly connectable to a hose 16 of a pump 14, a main tube 30 fluidly connected to the telescoping tube 20, a plurality of nozzles 40 fluidly connected within the main tube 30 extending downwardly, a pair of arms 50 attached to opposing ends of the main tube 30, a pair of cutouts 52 within the arms 50 for slidably receiving a corresponding pair of extended members 60, and a pair of wheels 70 attached to the extended members 60 for movably supporting the main tube 30 substantially parallel above a surface of a roof 12.

As shown in FIG. 1 of the drawings, the telescoping tube 20 is comprised of an elongate and adjustable structure. The telescoping tube 20 may be comprised of any number of sections as FIG. 1 simply illustrates an exemplary embodiment of the present invention. It can also be appreciated that a non-telescoping tube 20 may also be utilized in place of the telescoping tube 20 that has a sufficient length to reach upon the roof 12 surface. As further shown in FIG. 1 of the drawings, the telescoping tube 20 has an adjustable length sufficient to allow an individual to access the surface of the roof 12 having a pitch A with the telescoping tube 20 having a pitch B equal to or less than pitch A.

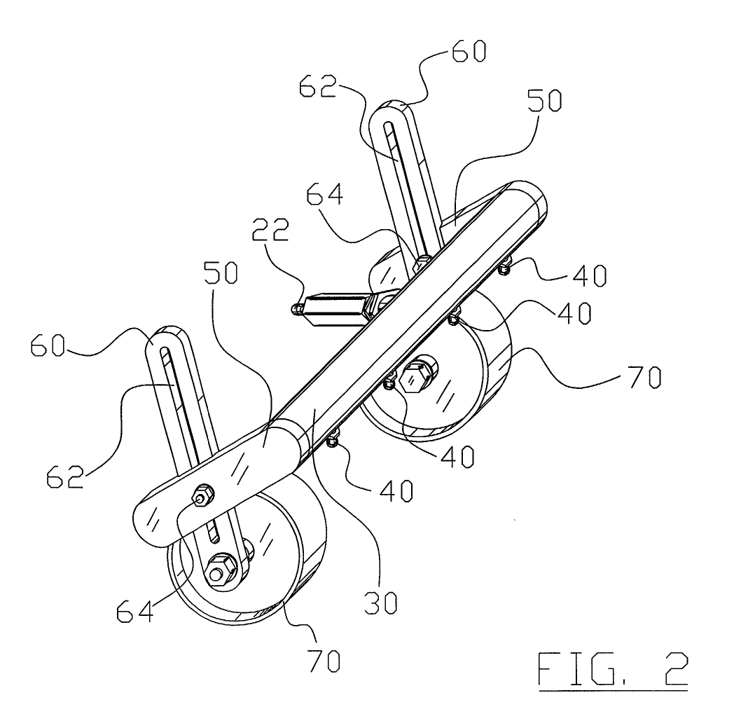

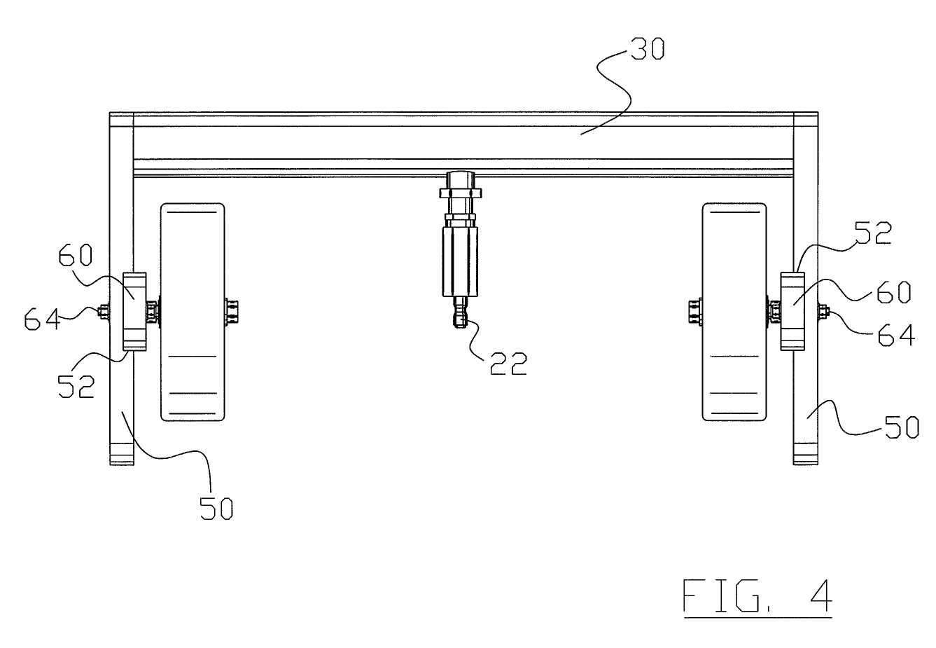

As further shown in FIG. 1 of the drawings, the telescoping tube 20 is fluidly connected to a hose 16 that is fluidly connected to a pump 14. The pump 14 may be comprised of any well-known fluid pump 14 structure such as but not limited pressure washer devices and the like. Various types of connective devices may be utilized to couple the hose 16 to the telescoping tube 20 and to couple the telescoping tube 20 to the main tube 30. FIGS. 2 and 4 illustrate an exemplary coupler 22 that may be utilized to connect the telescoping tube 20 to the main tube 30. It can be appreciated that the telescoping tube 20 may be permanently attached to the main tube 30 instead of utilizing a coupler 22.

As shown in FIGS. 2, 3, 5, 6 and 7 of the drawings, a plurality of nozzles 40 are fluidly positioned within the main tube 30 for directing pressurized water downwardly toward the surface of the roof 12. The nozzles 40 preferably extend downwardly from the main tube 30 at a specific distance apart from one another though various other configurations may be utilized. The nozzles 40 may be comprised of any well-known structure commonly utilized for nozzles 40. The nozzles 40 may be adjustable for allowing control of the direction of the water spray along with the water spray pattern. Various other nozzle configurations and structures may be utilized as can be appreciated along with various patters attached to the main tube 30.

As shown in FIGS. 1 through 8 of the drawings, a pair of arms 50 are attached to the opposing ends of the main tube 30. The arms 50 preferably extend rearwardly and downwardly away from the water stream directed from the nozzles 40. It can be appreciated that the arms 50 may extend downwardly and/or forwardly with respect to the main tube 30. The arms 50 may also have various lengths and shapes as can be appreciated.

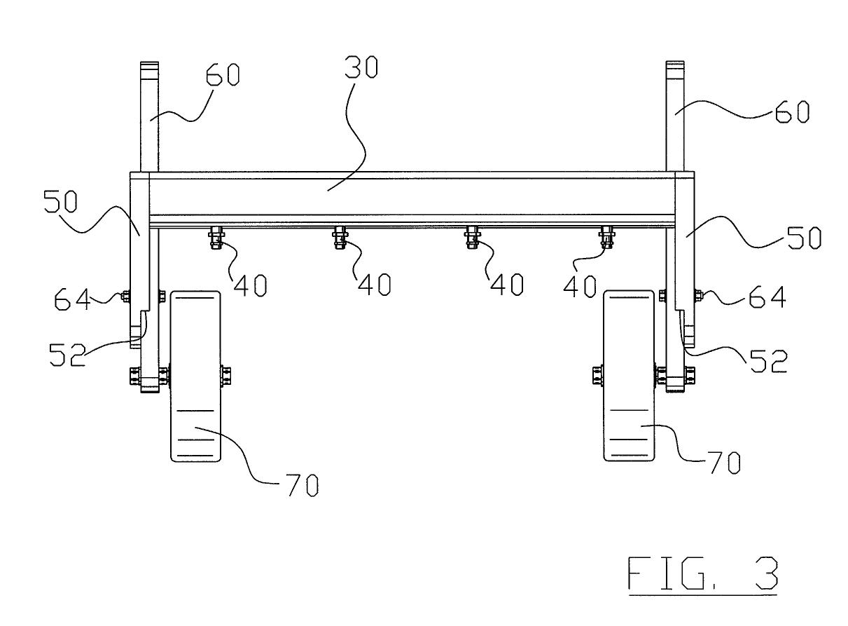

As best shown in FIGS. 3, 4 and 8 of the drawings, a pair of cutouts 52 extend into a portion of each of the arms 50. The cutouts 52 form a channel within the arms 50 that slidably receive a corresponding pair of extended members 60. Each of the extended members 60 includes a slot 62 for receiving a fastener 64 for securing the relative position of the extended members 60 within the arms 50 as best shown in FIG. 2 of the drawings.

As shown in FIGS. 1 through 7 of the drawings, a pair of wheels 70 are rotatably attached to the lower portion of the extended members 60 for movably supporting the main tube 30 substantially parallel to the surface of the roof 12. The wheels 70 may be comprised of any well-known structure commonly utilized for wheels 70. It can also be appreciated that more than two wheels 70 may be utilized with the present invention.

In use, the user extends the telescoping tube 20 to the appropriate length and then positions the present invention upon the roof 12 as shown in FIG. 1 of the drawings. The user then operates the pump 14 to provide pressurized water or other fluid through the telescoping tube 20 into the main tube 30. The pressurized fluid is then dispersed through the plurality of nozzles 40 toward the surface of the roof 12 for removing contaminates and the like. The user then moves the invention along the roof 12 in a desired pattern to clean the surface of the roof 12. The user continues this process until the roof 12 is cleaned as desired by the user. The user may adjust the nozzles 40 to the desired pattern and angle of spray which is well-known in the art. In addition, the user may adjust the relative position of the extended members 60 with respect to the arms 50 to adjust the overall height of the nozzles 40 above the surface of the roof 12. Various other obvious adjustments may be made to the invention to improve the overall performance as can be appreciated by one skilled in the art.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A roof cleaning system, comprising:
an elongate tube connectable to a pressurized water supply;
a main tube fluidly connected to said elongate tube;
a plurality of nozzles within said main tube;
a pair of arms extending from said main tube; and
a plurality of wheels rotatably attached to said pair of arms for movably supporting said main tube a finite distance above a surface.

2. The roof cleaning system of claim 1, wherein said pair of arms extend downwardly at an angle from said main tube.

3. The roof cleaning system of claim 2, wherein said pair of arms extend rearwardly from said main tube.

4. The roof cleaning system of claim 2, wherein said pair of arms extend forwardly from said main tube.

5. The roof cleaning system of claim 1, wherein said pair of arms extend downwardly from said main tube.

6. The roof cleaning system of claim 1, wherein said plurality of nozzles are equidistantly spaced apart.

7. The roof cleaning system of claim 1, wherein said plurality of nozzles are adjustable.

8. The roof cleaning system of claim 1, wherein said elongate tube is comprised of a telescoping tube.

9. The roof cleaning system of claim 1, wherein said elongate tube is comprised of a single tubular structure.

10. The roof cleaning system of claim 1, wherein said plurality of wheels are positioned rearwardly of said plurality of nozzles.

11. A roof cleaning system, comprising:
an elongate tube connectable to a pressurized water supply;
a main tube fluidly connected to said elongate tube;
a plurality of nozzles within said main tube;
a pair of arms extending from said main tube;
a cutout within each of said pair of arms;
a pair of extended members adjustably positioned within said cutout of each of said pair of arms; and
a plurality of wheels rotatably attached to said pair of extended members for adjustably supporting said main tube a finite distance above a surface.

12. The roof cleaning system of claim 11, wherein said pair of arms extend downwardly at an angle from said main tube.

13. The roof cleaning system of claim 12, wherein said pair of arms extend rearwardly from said main tube.

14. The roof cleaning system of claim 12, wherein said pair of arms extend forwardly from said main tube.

15. The roof cleaning system of claim 11, wherein said pair of arms extend downwardly from said main tube.

16. The roof cleaning system of claim 11, wherein said plurality of nozzles are equidistantly spaced apart.

17. The roof cleaning system of claim 11, wherein said plurality of nozzles are adjustable.

18. The roof cleaning system of claim 11, wherein said elongate tube is comprised of a telescoping tube.

19. The roof cleaning system of claim 11, wherein said elongate tube is comprised of a single tubular structure.

20. The roof cleaning system of claim 11, wherein said plurality of wheels are positioned rearwardly of said plurality of nozzles.
